(19) United States
(12) Patent Application Publication
(10) Pub. No.: US 2020/0108827 A1
(43) Pub. Date: Apr. 9, 2020

(54) VEHICLE CONTROL APPARATUS AND VEHICLE CONTROL METHOD

(71) Applicant: HONDA MOTOR CO., LTD.,, MINATO-KU, TOKYO (JP)

(72) Inventors: Tadahiko KANOH, WAKO-SHI, SAITAMA-KEN (JP); Jun OCHIDA, WAKO-SHI, SAITAMA-KEN (JP)

(21) Appl. No.: 16/495,647

(22) PCT Filed: Dec. 25, 2017
(86) PCT No.: PCT/JP2017/046487

§ 371 Date: Sep. 19, 2019

(30) Foreign Application Priority Data
Mar. 22, 2017 (JP) 2017-055282

(51) Int. Cl. B60W 30/12

(52) U.S. Cl. CPC B60W 30/12; B60W 2520/12; B60W 2520/125; B60W 2550/30

(57) ABSTRACT

The travel control unit of this vehicle control apparatus executes lane keeping control, lane departure suppression control or tracking control, switching from one to another according to a vehicle-width-direction behavior of a preceding vehicle located at or around an intersection through which a host vehicle is going to pass traveling straight ahead on a traveling lane.

### TECHNICAL FIELD

The present invention relates to a vehicle control device (apparatus) and a vehicle control method that perform travel control of a host vehicle at least partially automatically.

### BACKGROUND ART

A vehicle control device that performs travel control of a host vehicle at least partially automatically has conventionally been known. For example, various automated driving techniques to cause the host vehicle around an intersection to travel smoothly in consideration of the relation with another vehicle have been developed.

Japanese Laid-Open Patent Publication No. 2000-020896 discloses a vehicle control device. In a case where a preceding vehicle obstructs recognition of a lane, if it is predicted that a host vehicle is approaching a branch road or an intersection, the vehicle control device performs following control (what is called, ACC control) by lowering a control gain in a lateral direction.

### SUMMARY OF INVENTION

On the contrary, in a case where the preceding vehicle does not obstruct the recognition of the lane, there is a high possibility that a behavior of the host vehicle becomes stable when travel control is performed on the basis of the position of a travel lane (or lane mark) instead of a behavior of the preceding vehicle. In particular, in a case where it is difficult to specify operation intention of the preceding vehicle, for example, in the intersection, the behavior may become unstable due to continuation of predetermined travel control. Thus, the merchantability of the vehicle may be lost.

The present invention has been made to solve the above problem, and an object is to provide a vehicle control device and a vehicle control method that can improve the stability of a behavior when a host vehicle travels straight in an intersection.

A vehicle control device according to a first aspect of the present invention is a device configured to perform travel control of a host vehicle at least partially automatically, and the vehicle control device includes: an intersection recognition unit configured to recognize an intersection that the host vehicle will pass while traveling straight on a travel lane; an information acquisition unit configured to acquire preceding vehicle information expressing a behavior of a preceding vehicle in a vehicle width direction that precedes the host vehicle and is positioned at the intersection recognized by the intersection recognition unit or a periphery of the intersection; and a travel control unit configured to perform at least one of lane keeping control for the travel lane and departure prevention control for a lane mark that sections the travel lane, and following control for the preceding vehicle, wherein the travel control unit is configured to switch and perform the lane keeping control, the departure prevention control, or the following control in accordance with the behavior in the vehicle width direction that is specified from the preceding vehicle information acquired by the information acquisition unit.

As described above, the lane keeping control, the departure prevention control, or the following control is switched and performed in accordance with the behavior of the preceding vehicle in the vehicle width direction. Therefore, even in a case where it is difficult to specify operation intention of the preceding vehicle in the intersection or the periphery thereof, automated traveling or travel assistance can be continued by selecting the travel control that is suitable for each case. Thus, a behavior can be stabilized more when the host vehicle travels straight in the intersection.

The information acquisition unit may be configured to acquire a departure distance of the preceding vehicle based on a center line of the travel lane, and if the departure distance is within a predetermined range whose lower limit value is positive, the travel control unit may be configured to perform the following control, and if the departure distance is out of the distance range, the travel control unit may be configured to perform the lane keeping control or the departure prevention control.

If the preceding vehicle turns right or left at the intersection, the preceding vehicle tends to exhibit a travel behavior in which the departure distance from the center line becomes large, and if the preceding vehicle travels straight in the intersection, the preceding vehicle tends to exhibit the travel behavior in which the departure distance becomes small with the behavior fluctuation in the vehicle width direction. Thus, in the specific case where the departure distance is within the predetermined distance range, for example, if the preceding vehicle overtakes or passes in the intersection, the host vehicle can pass the intersection while following the preceding vehicle without stopping temporarily. On the other hand, if the departure distance is out of the distance range, the host vehicle can travel straight in the intersection smoothly without influence of the behavior of the preceding vehicle.

The information acquisition unit may be configured to acquire a departure distance of the preceding vehicle based on the lane mark, and if the departure distance is less than a predetermined threshold, the travel control unit may be configured to perform the following control, and if the departure distance is more than or equal to the threshold, the travel control unit may be configured to perform the lane keeping control or the departure prevention control. If the departure distance from the lane mark is large, there is a high possibility that the preceding vehicle is scheduled to change the lane or turn right or left, or is currently changing the lane or turning right or left. In this case, by switching to the lane keeping control or the departure prevention control, the behavior can be stabilized more when the host vehicle travels straight in the intersection.

The information acquisition unit may be configured to acquire lateral speed or lateral acceleration of the preceding vehicle, and if the preceding vehicle information is less than a predetermined threshold, the travel control unit may be configured to perform the following control, and if the preceding vehicle information is more than or equal to the threshold, the travel control unit may be configured to perform the lane keeping control or the departure prevention control. If the lateral speed or the lateral acceleration is large, there is a high possibility that the preceding vehicle is scheduled to change the lane or turn right or left, or is currently changing the lane or turning right or left. In this case, by switching to the lane keeping control or the departure prevention control, the behavior can be stabilized more when the host vehicle travels straight in the intersection.

The information acquisition unit may be configured to acquire a statistic value of the preceding vehicle information after the intersection recognition unit has recognized the intersection. If the statistic value to be used is the latest information and the fluctuation of the behavior is reduced in the statistic value, the determination when the travel control is switched can be performed with higher accuracy.

The information acquisition unit may be configured to acquire a movement direction of the preceding vehicle, and if a right/left-turn only lane exists in the movement direction with respect to a position of the preceding vehicle, the travel control unit may be configured to perform the lane keeping control or the departure prevention control, and if the right/left-turn only lane does not exist in the movement direction, the travel control unit may be configured to perform the following control. If the right/left-turn only lane exists in the movement direction with respect to the position of the preceding vehicle, there is a high possibility that the preceding vehicle is scheduled to change the lane and turn right or left, or is currently changing the lane and turning right or left. In this case, by switching to the lane keeping control or the departure prevention control, the behavior can be stabilized more when the host vehicle travels straight in the intersection.

The information acquisition unit may be configured to acquire an elapsed time or a travel distance for which the preceding vehicle continuously stays out of the travel lane, and if the preceding vehicle information is less than a predetermined threshold, the travel control unit may be configured to perform the following control, and if the preceding vehicle information is more than or equal to the threshold, the travel control unit may be configured to perform the lane keeping control or the departure prevention control. If the elapsed time or the travel distance for which the preceding vehicle continuously stays out of the travel lane is large, there is a high possibility that the preceding vehicle is scheduled to change the lane or turn right or left, or is currently changing the lane or turning right or left. In this case, by switching to the lane keeping control or the departure prevention control, the behavior can be stabilized more when the host vehicle travels straight in the intersection.

A vehicle control method according to a second aspect of the present invention is a method using a vehicle control device configured to perform travel control of a host vehicle at least partially automatically, and the vehicle control method includes: a recognition step of recognizing an intersection that the host vehicle will pass while traveling straight on a travel lane; an acquisition step of acquiring preceding vehicle information expressing a behavior of a preceding vehicle in a vehicle width direction that precedes the host vehicle and is positioned at the intersection that is recognized or a periphery of the intersection; and a control step of performing at least one of lane keeping control for the travel lane and departure prevention control for a lane mark that sections the travel lane, and following control for the preceding vehicle, wherein in the control step, the lane keeping control, the departure prevention control, or the following control is switched and performed in accordance with the behavior in the vehicle width direction that is specified from the preceding vehicle information that is acquired.

By the vehicle control device and the vehicle control method according to the present invention, the behavior can be stabilized more when the host vehicle travels straight in the intersection.

### BRIEF DESCRIPTION OF DRAWINGS

FIG. 1 is a block diagram illustrating a configuration of a vehicle control device according to one embodiment of the present invention;

FIG. 2 is a flowchart for describing an operation of the vehicle control device illustrated in FIG. 1;

FIG. 3A and FIG. 3B illustrate one example of an intersection that is recognized in step S2 in FIG. 2;

FIG. 4 is a detailed flowchart regarding a control switch determination based on a behavior of a preceding vehicle (step S3 in FIG. 2);

FIG. 5A and FIG. 5B illustrate one example of preceding vehicle information;

FIG. 6A and FIG. 6B illustrate one example of the preceding vehicle information;

FIG. 7A and FIG. 7B illustrate a setting example of a determination condition;

FIG. 8A and FIG. 8B illustrate a first example of a travel behavior of a host vehicle;

FIG. 9A and FIG. 9B illustrate a second example of the travel behavior of the host vehicle; and

FIG. 10A and FIG. 10B illustrate a third example of the travel behavior of the host vehicle.

### DESCRIPTION OF EMBODIMENTS

A preferred embodiment of a vehicle control device according to the present invention in relation with a vehicle control method is hereinafter described with reference to the attached drawings.

### [Configuration of Vehicle Control Device 10]

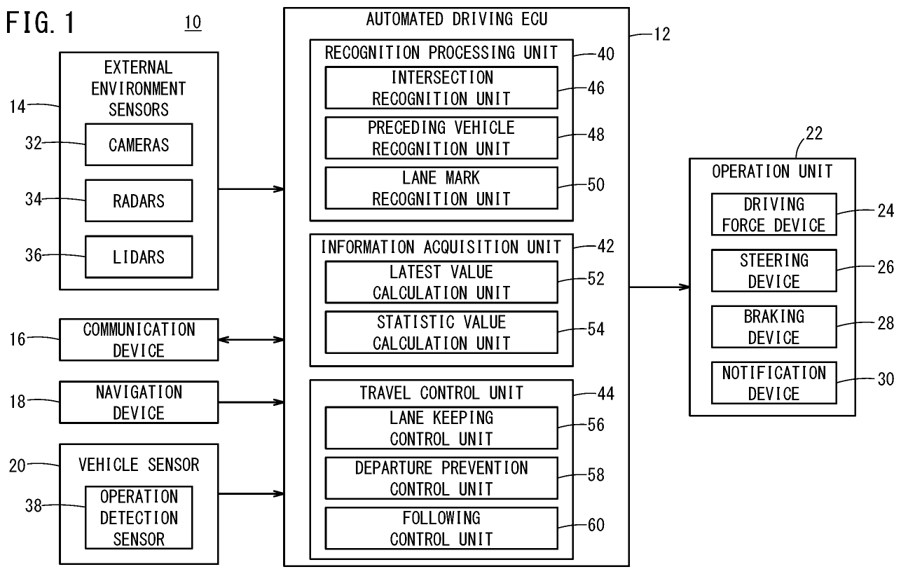

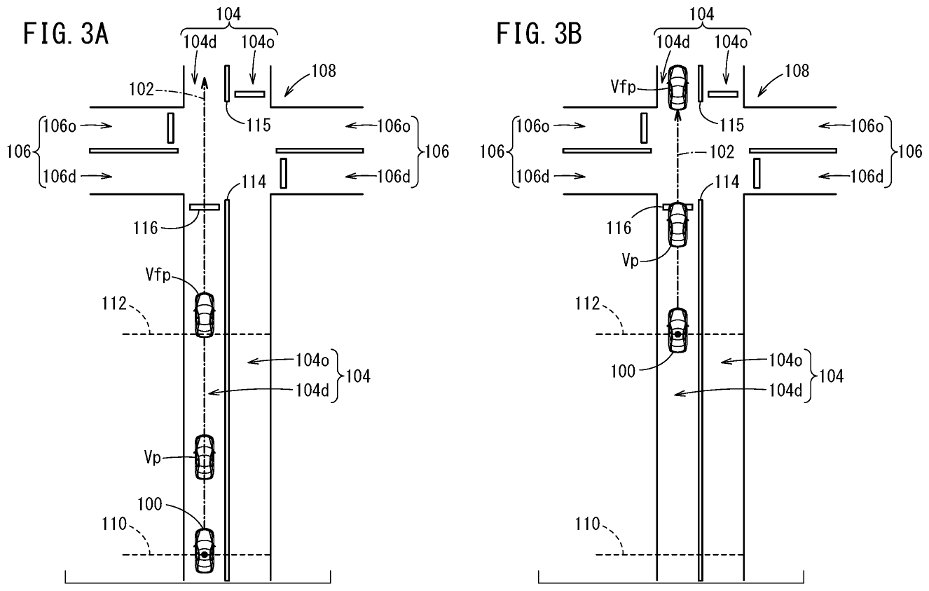

FIG. 1 is a block diagram illustrating a configuration of a vehicle control device 10 according to one embodiment of the present invention. The vehicle control device 10 is incorporated in a vehicle (host vehicle 100 in FIG. 3A, etc.), and performs travel control of the vehicle automatically or manually. This “automated driving” refers to a concept including not just “fully automated driving” in which the travel control of the vehicle is fully automated but also “partial automated driving” in which the travel control is partially automated.

The vehicle control device 10 basically includes an input system device group, an automated driving ECU (Electronic Control Unit) 12, and an output system device group. Devices in the input system device group and the output system device group are connected to the automated driving ECU 12 through communication lines.

The input system device group includes external environment sensors 14, a communication device 16, a navigation device 18, and a vehicle sensor 20. The output system device group (corresponding to an operation unit 22) includes a driving force device 24 that drives wheels, a steering device 26 that steers the wheels, a braking device 28 that brakes the wheels, and a notification device 30 that notifies a driver.

### <Specific Configuration of Input System Device Group>

The external environment sensors 14 acquire information expressing an external environment state of the vehicle (hereinafter, external environment information), and output the external environment information to the automated driving ECU 12. The external environment sensors 14 specifically include a plurality of cameras 32, a plurality of radars 34, and a plurality of LIDARs 36 (Light Detection and Ranging, Laser Imaging Detection and Ranging).

The communication device 16 is configured to be able to communicate with an external device including a road side machine, another vehicle, and a server. For example, the communication device 16 transmits and receives information regarding traffic equipment, information regarding other vehicles, probe information, or map information that is the latest.

The navigation device 18 includes a satellite positioning device that can detect the current position of the vehicle, and a user interface. The navigation device 18 calculates a route to a designated destination on the basis of the current position of the vehicle or the position designated by the user, and outputs to the automated driving ECU 12, route information that expresses this route.

The vehicle sensor 20 includes a speed sensor that detects travel speed of the vehicle (vehicle speed), an acceleration sensor that detects acceleration, a lateral acceleration sensor that detects lateral acceleration, a yaw rate sensor that detects angular speed around a vertical axis, an azimuth sensor that detects a direction/azimuth, and an inclination sensor that detects inclination. The vehicle sensor 20 outputs detection signals from these sensors to the automated driving ECU 12.

The vehicle sensor 20 further includes an operation detection sensor 38 that detects the operation amount or an operation position of an operation device (not shown). This operation device includes, for example, an accelerator pedal, a steering wheel, a brake pedal, a shift lever, and a direction indicating lever.

### <Specific Configuration of Output System Device Group>

The driving force device 24 includes a driving force control ECU and a driving source including an engine or a traction motor. The driving force device 24 generates travel driving force (torque) for the vehicle in accordance with a travel control value that is input from the automated driving ECU 12 (more specifically, travel control unit 44), and transmits the travel driving force to the wheels directly or indirectly through a transmission.

The steering device 26 includes an EPS (electric power steering system) ECU and an EPS device. The steering device 26 changes the direction of the wheels (steering wheels) in accordance with the travel control value that is input from the travel control unit 44.

The braking device 28 is, for example, an electric servo brake that is used in combination with a hydraulic brake, and includes a braking force control ECU and a brake actuator. The braking device 28 brakes the wheels in accordance with the travel control value that is input from the travel control unit 44.

The notification device 30 includes a notification control device, a display device, and an audio device. The notification device 30 performs a notification operation regarding the automated driving or the manual driving in accordance with a notification instruction that is output from the automated driving ECU 12.

### <Configuration of Automated Driving ECU 12>

The automated driving ECU 12 is configured by one or a plurality of ECUs, and each function achievement unit is a software function unit that achieves a function when one or a plurality of CPUs (Central Processing Units) execute programs stored in the storage device that is non-transitory. The function achievement unit may alternatively be a hardware function unit including an integrated circuit such as an FPGA (Field-Programmable Gate Array).

The automated driving ECU 12 can be switched between an automated driving mode and a manual driving mode in accordance with an operation of an automated driving switch (not shown). Here, the automated driving mode is a driving mode in which, in a state where the driver does not operate the operation device, the automated driving ECU 12 controls at least a part of the driving force device 24, the steering device 26, and the braking device 28 in accordance with an action plan that is created or updated successively.

Specifically, the automated driving ECU 12 includes a recognition processing unit 40, an information acquisition unit 42, and the travel control unit 44. The recognition processing unit 40 functions as an intersection recognition unit 46, a preceding vehicle recognition unit 48, and a lane mark recognition unit 50. The information acquisition unit 42 functions as a latest value calculation unit 52 and a statistic value calculation unit 54. The travel control unit 44 functions as a lane keeping control unit 56, a departure prevention control unit 58, and a following control unit 60.

The recognition processing unit 40 recognizes lane marks (while lines) on both sides of the vehicle with reference to various pieces of information input from the input system device group (such as external environment information from the external environment sensors 14), and generates “static” external environment recognition information including positional information about a stop line and a traffic signal or a travel possible area. In addition, the recognition processing unit 40 generates “dynamic” external environment recognition information including an obstacle such as a parked or stopped vehicle, a traffic participant such as a person or another vehicle, or the color of the traffic signal with reference to various pieces of information that are input.

By using the external environment recognition information that is generated by the recognition processing unit 40, the information acquisition unit 42 acquires information that expresses a behavior of a preceding vehicle Vp in a vehicle width direction (hereinafter, preceding vehicle information), or a statistic value of the preceding vehicle information. This preceding vehicle information is used in a calculation process that is performed by the travel control unit 44 (“control switch determination” to be described below).

By using the external environment recognition information that is generated by the recognition processing unit 40, the travel control unit 44 generates a travel trajectory (target behavior in time series) in accordance with the action plan for each travel section, and then, decides various travel control values for controlling the travel of the vehicle. The travel control unit 44 outputs the obtained travel control values to the driving force device 24, the steering device 26, and the braking device 28.

Note that the travel control unit 44 can perform lane keeping control by the lane keeping control unit 56 (for example, LKAS control; Lane Keeping Assist System), departure prevention control by the departure prevention control unit 58 (for example, LDPS control; Lane Departure Prevention System), and following control by the following control unit 60 (for example, ACC control; Adaptive Cruise Control).

Here, the term “lane keeping control” means travel control to cause the vehicle to travel along a target trajectory (for example, center line) on a travel lane 104d (for example, FIG. 3A). The term “departure prevention control” means travel control to cause the vehicle to travel so that the departure from a lane mark 114 (for example, FIG. 3A) to the outside is suppressed or prevented. The term “following control” means travel control to cause the vehicle to travel while following the preceding vehicle Vp (for example, FIG. 3A).

### [Operation of Vehicle Control Device 10]

### <Overall Procedure>

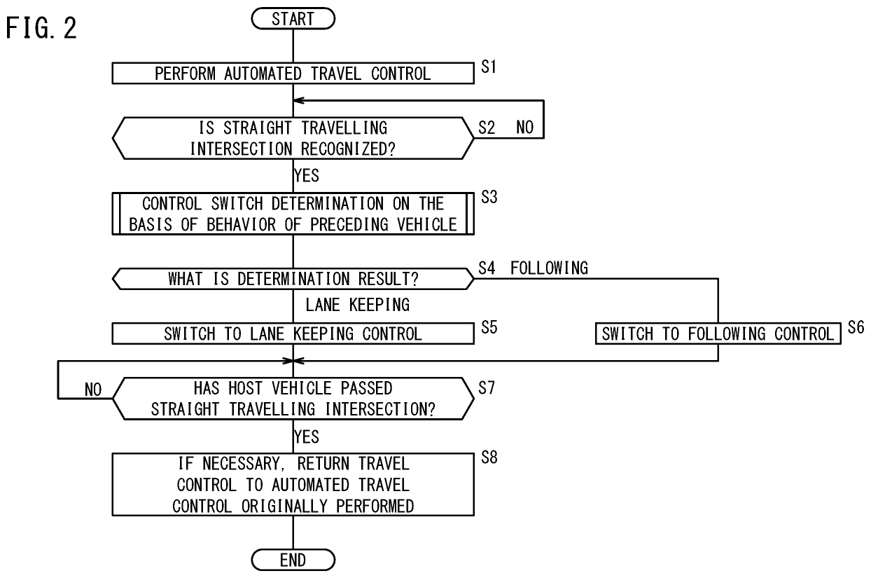

The vehicle control device 10 according to the present embodiment is configured as above. Next, an operation of the vehicle control device 10 before and after passing of an intersection 108 is described with reference to a flowchart in FIG. 2. Here, it is assumed that the host vehicle 100 including the vehicle control device 10 in FIG. 1 travels by the automated driving mode.

In step S1 in FIG. 2, the travel control unit 44 performs automated travel control for the host vehicle 100. Here, it is assumed that the travel control unit 44 basically performs the lane keeping control among the lane keeping control, the departure prevention control, and the following control.

In step S2, the intersection recognition unit 46 determines whether the intersection recognition unit 46 can recognize the intersection 108 (straight travelling intersection) where the host vehicle 100 travels straight and passes on the basis of detection results from the external environment sensors 14.

As illustrated in FIG. 3A and FIG. 3B, the host vehicle 100 will pass a point where a first road 104 and a second road 106 intersect (that is, the intersection 108) along a scheduled travel route 102 that is expressed by a dashed line arrow. These drawings express the roads in a region where vehicles travel in “left side” of the road.

The first road 104 that is formed by two lanes includes the travel lane 104d where the host vehicle 100 is scheduled to travel, and an opposite lane 104o that is opposite to the travel lane 104d. The second road 106 that is formed by two lanes includes a travel lane 106d and an opposite lane 106o that is opposite to the travel lane 106d.

As illustrated in these drawings, three vehicles including the host vehicle 100 travel in the same travel lane 104d. Among two other vehicles V, a vehicle that precedes the host vehicle 100 is referred to as “preceding vehicle Vp”, and a vehicle that precedes the preceding vehicle Vp is referred to as “further-preceding vehicle Vfp”.

Note that a recognition position 110 expressed by a broken line is a position of the host vehicle 100 when the intersection recognition unit 46 recognizes the intersection 108 at the first time (recognition start time point). For the convenience of description, it is hereinafter assumed that, after the recognition start time point, the preceding vehicle recognition unit 48 can recognize the further-preceding vehicle Vfp and the preceding vehicle Vp, and the lane mark recognition unit 50 can recognize lane marks 114, 115.

If the intersection 108 is not recognized (step S2: NO), the process returns to step S2 and step S2 is repeated until the intersection 108 is recognized. On the other hand, if the host vehicle 100 reaches the recognition position 110 and the intersection 108 is recognized (step S2: YES), the process advances to the next step S3.

In step S3, the travel control unit 44 performs the control switch determination on the basis of the behavior of the preceding vehicle Vp. As described below, when the host vehicle 100 has reached a determination position 112 (FIG. 3B), the travel control unit 44 performs the determination to select the travel control among the lane keeping control, the departure prevention control, and the following control. In this embodiment, for example, the travel control can be selected from two kinds of the travel control (lane keeping control/following control).

In step S4, the travel control unit 44 switches the travel control in accordance with a determination result in step S3. For example, if the travel control unit 44 determines “lane keeping”, the lane keeping control is performed (step S5), and on the other hand, if the travel control unit 44 determines “following”, the following control is performed (step S6).

In step S7, the automated driving ECU 12 determines whether the host vehicle 100 has passed the intersection 108. If the host vehicle 100 has not passed the intersection 108 yet (step S7: NO), the process returns to step S7 and step S7 is repeated until the host vehicle 100 passes the intersection 108. On the other hand, if the host vehicle 100 has passed the intersection 108 (step S7: YES), the process advances to the next step S8.

In step S8, if necessary, the travel control unit 44 returns the travel control to the automated travel control that is originally performed. Specifically, if step S5 is selected, the travel control unit 44 keeps the lane keeping control, and on the other hand, if step S6 is selected, the travel control unit 44 switches from the following control to the lane keeping control.

### <Details of Control Switch Determination>

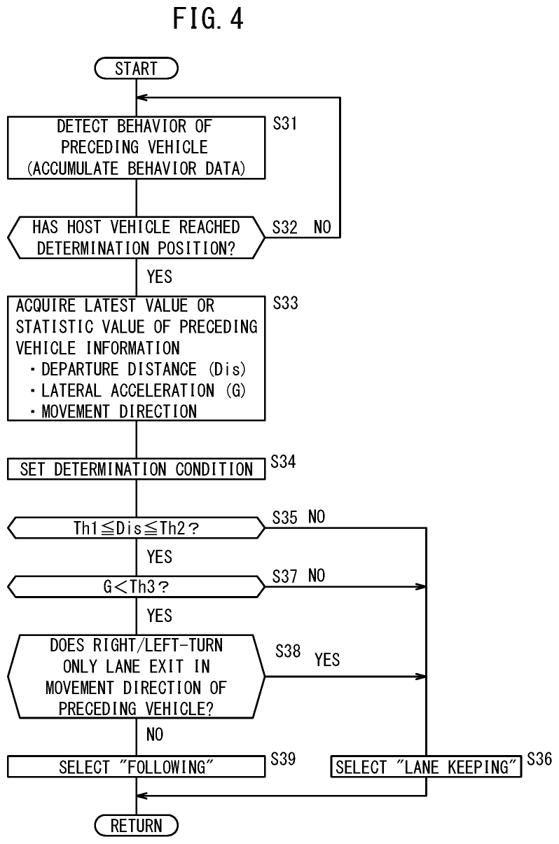

Next, the control switch determination (step S3 in FIG. 2) based on the behavior of the preceding vehicle Vp (FIG. 3A and FIG. 3B) is described in detail with reference to a flowchart in FIG. 4.

In step S31 in FIG. 4, the preceding vehicle recognition unit 48 recognizes the behavior of the preceding vehicle Vp in accordance with the detection results from the external environment sensors 14, and generates behavior data in the vehicle width direction (lateral direction). The behavior data to be acquired includes, for example, a position in the vehicle width direction, a movement direction, a speed, an acceleration, and a jerk.

In step S32, the automated driving ECU 12 determines whether the host vehicle 100 has reached the determination position 112. This determination position 112 exists between the recognition position 110 and the intersection 108, and exists at a predetermined distance from a stop line 116 to the host vehicle 100 side.

If the host vehicle 100 has not reached the determination position 112 yet (step S32: NO), the process returns to step S31 and steps S31, S32 are successively repeated until the host vehicle 100 reaches the determination position 112. On the other hand, if the host vehicle 100 has reached the determination position 112 (step S32: YES), the process advances to step S33. That is to say, while the host vehicle 100 travels in a section from the recognition position 110 to the determination position 112, the behavior data of the preceding vehicle Vp in time series is accumulated.

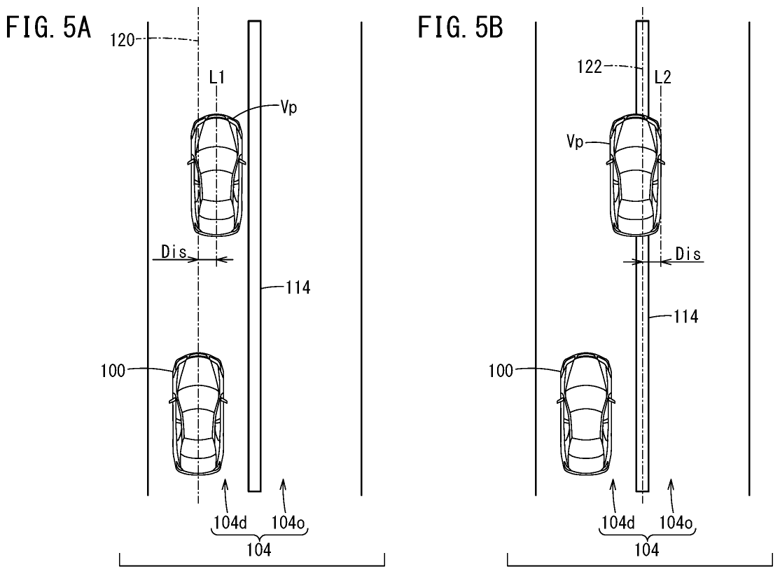

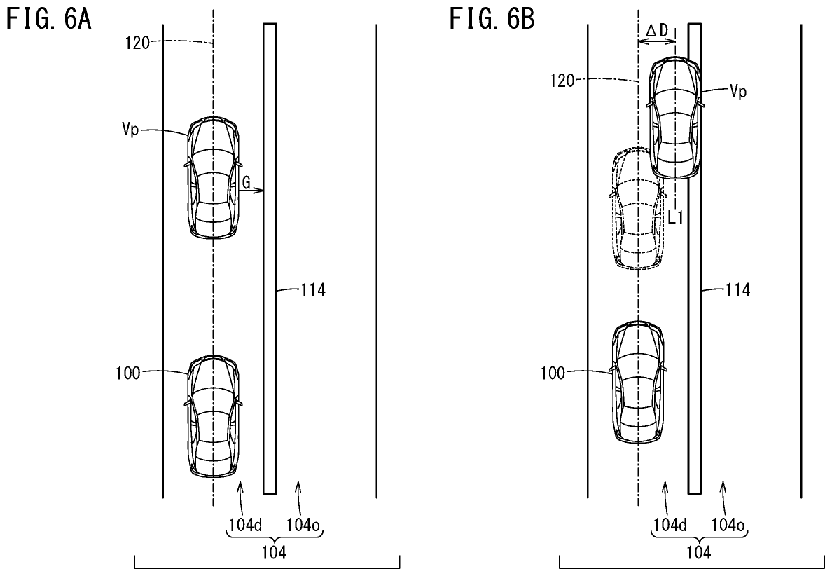

In step S33, the information acquisition unit 42 acquires the latest value or a statistic value of the preceding vehicle information about the preceding vehicle Vp. One example of the preceding vehicle information is hereinafter described in detail with reference FIG. 5A to FIG. 6B.

In an example illustrated in FIG. 5A, a departure distance Dis is defined as a distance between a virtual center line of the travel lane 104d and the preceding vehicle Vp. Specifically, the departure distance Dis corresponds to a distance between a lane center line 120 and a vehicle center line L1 of the preceding vehicle Vp.

In an example illustrated in FIG. 5B, the departure distance Dis is defined as a distance between the lane mark 114 and the preceding vehicle Vp. Specifically, the departure distance Dis corresponds to a distance between a lane border line 122 and a vehicle body right end line L2 of the preceding vehicle Vp. Alternatively, “elapsed time” or “travel distance” that continuously satisfies Dis>0 may be defined.

In an example illustrated in FIG. 6A, lateral acceleration G is defined as absolute acceleration of the preceding vehicle Vp in the vehicle width direction. Similarly, absolute speed in the vehicle width direction may be defined as “lateral speed”. As the movement direction, a direction away from the lane center line 120 is a “positive direction”, and a direction approaching the lane center line 120 is a “negative direction”.

In an example illustrated in FIG. 6B, a movement amount AD is the displacement amount of the preceding vehicle Vp in the vehicle width direction, and is predicted by using the latest values of the lateral speed and a lateral jerk in addition to the lateral acceleration G (FIG. 6A). As described above, the preceding vehicle information is not limited to “instantaneous values” that include the departure distance Dis, the lateral acceleration G, and the movement direction, and may be a “predicted value” that can be calculated by using these instantaneous values.

The latest value calculation unit 52 calculates a “latest value” that easily reflects the latest operation intension by the preceding vehicle Vp. Thus, the behavior of the preceding vehicle Vp can be predicted with higher accuracy. In addition or alternatively, the statistic value calculation unit 54 may calculate a “statistic value” of the preceding vehicle information in consideration of a tendency of the fluctuation (instability) in the behavior of the preceding vehicle Vp.

This “statistic value” is a value that is calculated by using a statistical method, and includes, for example, the mean, the mode, the median, the maximum, the minimum, the standard deviation, the variance, and the maximum of the mean residual. In addition, if the preceding vehicle information is data in time series, the statistic value also includes a result that is smoothed by using the moving average or the like.

As described above, the information acquisition unit 42 may acquire the statistic value of the preceding vehicle information after the intersection recognition unit 46 recognizes the intersection 108. If the statistic value to be used is the latest information and the fluctuation of the behavior is reduced in the statistic value, the determination when the travel control is switched can be performed with higher accuracy.

In step S34, the travel control unit 44 sets a determination condition to switch the automated travel control by using the preceding vehicle information that is acquired in step S33. Specifically, the travel control unit 44 decides the kind of the preceding vehicle information and then, sets one or a plurality of thresholds to be used in the determination process.

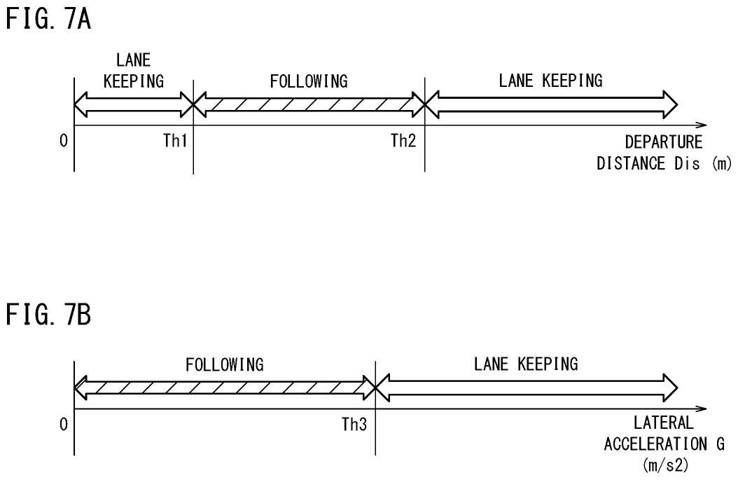

FIG. 7A illustrates a result of setting a distance range where the following control is performed. Here, a threshold Th1 is a lower limit value of the distance range and a threshold Th2 is an upper limit value of the distance range. That is to say, 0≤Dis<Th1 is a “lane keeping” range, Th1≤Dis≤Th2 is a “following” range, and Dis>Th2 is the “lane keeping” range.

The threshold Th1 is set to a positive value (Th1>0) in the definition in FIG. 5A, and is set to zero (Th1=0) in the definition in FIG. 5B. Moreover, the threshold Th2 is set to a relatively large value in the definition in FIG. 5A, and is set to a relatively small value in the definition in FIG. 5B.

FIG. 7B illustrates a result of setting an acceleration range where the following control is performed. If a positive threshold Th3 is an upper limit value of the acceleration range, 0≤G≤Th3 indicates the “following” range and G≥Th3 indicates the “lane keeping” range.

In step S35, the travel control unit 44 determines whether the departure distance Dis corresponding to one piece of the preceding vehicle information is within the distance range that is set in step S34. If the relation of Dis<Th1 or Dis>Th2 is satisfied (step S35: NO), “lane keeping” is selected (step S36). On the other hand, if the relation of Th1≤Dis≤Th2 is satisfied (step S35: YES), the process advances to step S37.

In step S37, the travel control unit 44 determines whether the lateral acceleration G corresponding to one piece of the preceding vehicle information is within the acceleration range that is set in step S34. If the relation of G≥Th3 is satisfied (step S37: NO), “lane keeping” is selected (step S36). On the other hand, if the relation of G≤Th3 is satisfied (step S37: YES), the process advances to step S38.

In step S38, the travel control unit 44 determines whether a right/left-turn only lane exists in the movement direction corresponding to one piece of the preceding vehicle information with respect to the position of the preceding vehicle Vp. If the right/left-turn only lane exits (step S38: YES), “lane keeping” (step S36) is selected, and if the right/left-turn only lane does not exit (step S38: NO), “following” (step S39) is selected.

[Travel Behavior of Host vehicle 100]

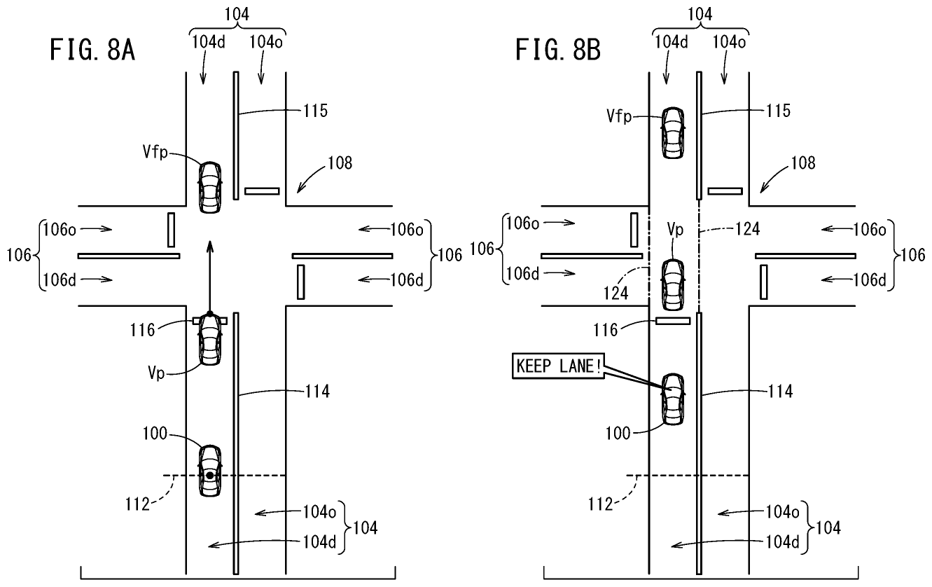

As described above, the control switch determination by the travel control unit 44 is terminated (step S3 in FIG. 2). Next, specific examples of a travel behavior of the host vehicle 100 are described with reference to FIG. 8A to FIG. 10B.

### FIRST EXAMPLE

In a case illustrated in FIG. 8A, near the intersection 108, the obstacle that obstructs the travel on the travel lane 104d does not exit. If both the further-preceding vehicle Vfp and the preceding vehicle Vp travel straight in the intersection 108, the preceding vehicle Vp will travel in the travel lane 104d while keeping the present travel behavior. In this case, the travel behavior in the vehicle width direction (departure distance Dis) becomes relatively small; therefore, “lane keeping” is selected as the travel control for the host vehicle 100.

As illustrated in FIG. 8B, the travel control unit 44 (lane keeping control unit 56) sets two virtual lines 124 that connect the lane marks 114, 115 or the like so as to fix the target trajectory in the intersection 108 and then, the lane keeping control for the travel lane 104d is performed. Note that if the following control is selected, the behavior of the host vehicle 100 may become unstable due to the influence of the behavior of the preceding vehicle Vp.

### SECOND EXAMPLE

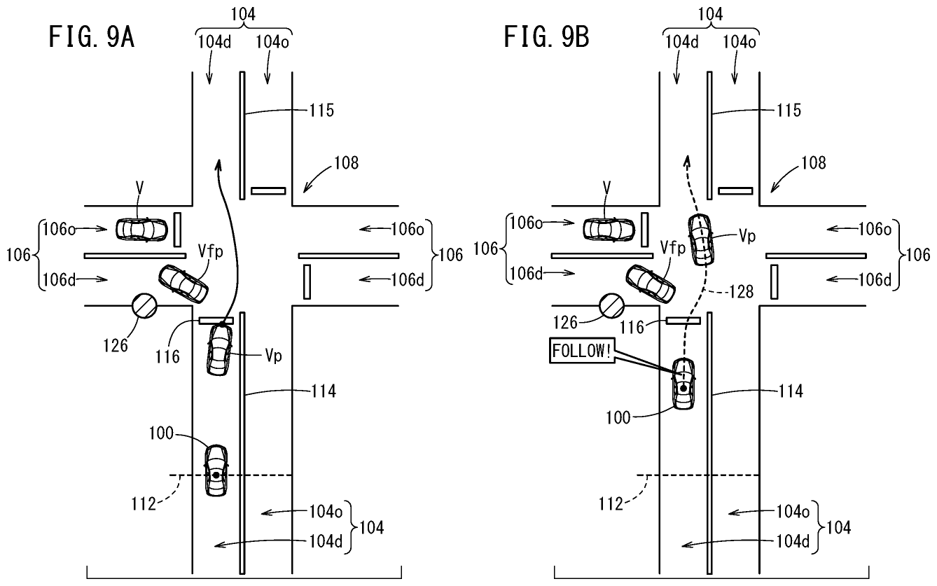

In a case illustrated in FIG. 9A, near the intersection 108, an obstacle 126 exists on the travel lane 106d and the other vehicle V exists on the opposite lane 106o. It is assumed that the further-preceding vehicle Vfp will turn left at the intersection 108, and on the other hand, the preceding vehicle Vp will travel straight at the intersection 108.

The further-preceding vehicle Vfp turns left while avoiding the contact with the obstacle 126 and the other vehicle V. Thus, it takes time to leave the travel lane 104d. As a result, the preceding vehicle Vp travels along a trajectory expressed by a solid line arrow in the travel lane 104d, and tries to overtake the further-preceding vehicle Vfp. In this case, the behavior in the vehicle width direction becomes relatively large; therefore, “following” is selected as the travel control for the host vehicle 100.

As illustrated in FIG. 9B, the travel control unit 44 (following control unit 60) performs the following control (what is called, trajectory following control) for the preceding vehicle Vp so that the host vehicle 100 follows along a travel trajectory 128 expressed by a broken line arrow. Note that if the lane keeping control or the departure prevention control is selected, the host vehicle 100 does not depart from the travel lane 104d. Thus, the host vehicle 100 may temporarily stop just before the further-preceding vehicle Vfp.

### THIRD EXAMPLE

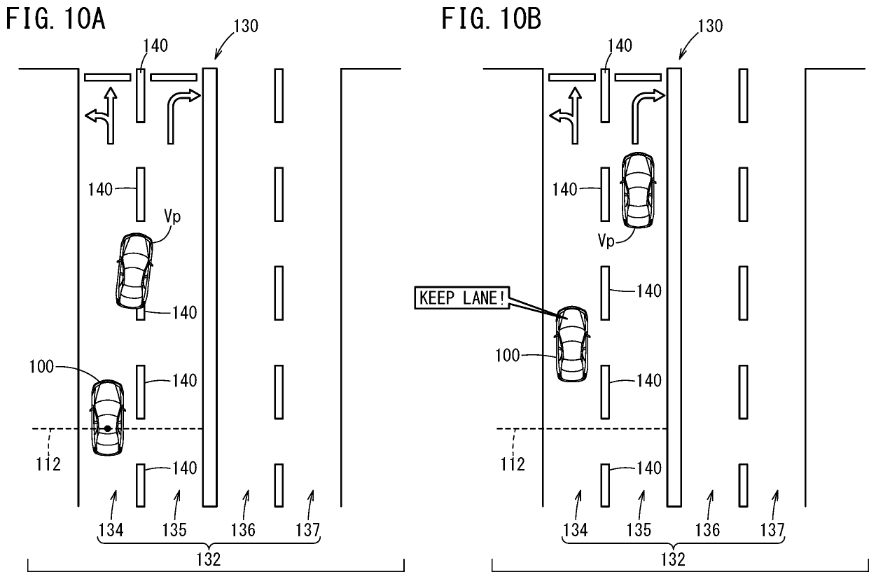

In a case illustrated in FIG. 10A, the host vehicle 100 travels on a road 132 that leads to an intersection 130 and includes four lanes. The road 132 includes, from a left side thereof in this order, a travel lane 134 for the host vehicle 100, a right-turn lane 135 (right/left-turn only lane), and two opposite lanes 136, 137. The travel lane 134 and the right-turn lane 135 are sectioned by a lane mark 140 with a broken line shape.

The preceding vehicle Vp tries to change from “straight/left-turn lane” to “right-turn only lane” before the intersection 130 in order to pass the intersection 130 by turning right. In this case, in the movement direction of the preceding vehicle Vp, the right-turn lane 135 exists. Thus, “lane keeping” is selected as the travel control for the host vehicle 100.

As illustrated in FIG. 10B, the travel control unit 44 (lane keeping control unit 56) fixes the target trajectory at the intersection 130 or the periphery thereof by recognizing the position of the lane mark 140, and performs the lane keeping control for the travel lane 134.

### [Effect of Vehicle Control Device 10]

As described above, the vehicle control device 10 is configured to perform the travel control of the host vehicle 100 at least partially automatically, and includes: [1] the intersection recognition unit 46 configured to recognize the intersection 108 (130) that the host vehicle 100 will pass while traveling straight on the travel lane 104d (134); [2] the information acquisition unit 42 configured to acquire the preceding vehicle information expressing the behavior of the preceding vehicle Vp in the vehicle width direction that precedes the host vehicle 100 and is positioned at the intersection 108 (130) that is recognized or the periphery thereof; and [3] the travel control unit 44 configured to perform at least one of the lane keeping control and the departure prevention control, and following control, wherein [4] the travel control unit 44 is configured to switch and perform the lane keeping control, the departure prevention control, or the following control in accordance with the behavior in the vehicle width direction that is specified from the preceding vehicle information.

The vehicle control method using the vehicle control device 10 includes: [1] the recognition step (S2 in FIG. 2) of recognizing the intersection 108 (130); [2] the acquisition step (S33 in FIG. 4) of acquiring the preceding vehicle information; and [3] the control step (S5, S6 in FIG. 2) of performing at least one of the lane keeping control and the departure prevention control, and the following control, wherein [4] in the control step, the lane keeping control, the departure prevention control, or the following control is switched and performed in accordance with the behavior of the preceding vehicle Vp in the vehicle width direction.

By this configuration, even in the case where it is difficult to specify the operation intention of the preceding vehicle Vp in the intersection 108 (130) or the periphery thereof, the automated traveling or the travel assistance can be continued by selecting the travel control that is suitable for each case. Thus, the behavior can be stabilized more when the host vehicle 100 travels straight in the intersection 108 (130).

The information acquisition unit 42 may be configured to acquire the departure distance Dis (FIG. 5A) of the preceding vehicle Vp based on the lane center line 120, and if the departure distance Dis is within the predetermined range whose lower limit value is positive, the travel control unit 44 may be configured to perform the following control, and if the departure distance Dis is out of the distance range, the travel control unit 44 may be configured to perform the lane keeping control or the departure prevention control.

If the preceding vehicle Vp turns right or left at the intersection 108 (130), the preceding vehicle Vp tends to exhibit the travel behavior in which the departure distance Dis from the lane center line 120 becomes large, and if the preceding vehicle Vp travels straight in the intersection 108 (130), the preceding vehicle Vp tends to exhibit the travel behavior in which the departure distance Dis becomes small with the behavior fluctuation in the vehicle width direction. Thus, in the specific case where the departure distance Dis is within the predetermined distance range, for example, if the preceding vehicle Vp overtakes or passes in the intersection 108 (130), the host vehicle 100 can pass the intersection 108 while following the preceding vehicle Vp without stopping temporarily. On the other hand, if the departure distance Dis is out of the distance range, the host vehicle 100 can travel straight in the intersection 108 (130) smoothly without the influence of the behavior of the preceding vehicle Vp.

The information acquisition unit 42 may be configured to acquire the departure distance Dis (FIG. 5B) of the preceding vehicle Vp based on the lane mark 114, and if the departure distance Dis is less than the predetermined threshold, the travel control unit 44 may be configured to perform the following control, and if the departure distance Dis is more than or equal to the threshold, the travel control unit 44 may be configured to perform the lane keeping control or the departure prevention control.

The information acquisition unit 42 may be configured to acquire the lateral speed or the lateral acceleration G of the preceding vehicle Vp, and if the preceding vehicle information is less than the predetermined threshold, the travel control unit 44 may be configured to perform the following control, and if the preceding vehicle information is more than or equal to the threshold, the travel control unit 44 may be configured to perform the lane keeping control or the departure prevention control.

The information acquisition unit 42 may be configured to acquire the movement direction of the preceding vehicle Vp, and if the right-turn lane 135 (right/left-turn only lane) exists in the movement direction with respect to the position of the preceding vehicle Vp, the travel control unit 44 may be configured to perform the lane keeping control or the departure prevention control, and if the right-turn lane 135 does not exist in the movement direction, the travel control unit 44 may be configured to perform the following control.

The information acquisition unit 42 may be configured to acquire the elapsed time or the travel distance for which the preceding vehicle Vp continuously stays out of the travel lane 104d, and if the preceding vehicle information is less than the predetermined threshold, the travel control unit 44 may be configured to perform the following control, and if the preceding vehicle information is more than or equal to the threshold, the travel control unit 44 may be configured to perform the lane keeping control or the departure prevention control.

[1] If the departure distance Dis from the lane mark 114 is large, [2] if the lateral speed or the lateral acceleration G is large, [3] if the right-turn lane 135 exists in the movement direction with respect to the position of the preceding vehicle Vp, or [4] if the elapsed time or the travel distance for which the preceding vehicle Vp continuously stays out of the travel lane 104d is large, there is a high possibility that the preceding vehicle Vp is scheduled to turn right or left or is currently turning right or left. In this case, by switching to the lane keeping control or the departure prevention control, the behavior can be stabilized more when the host vehicle 100 travels straight in the intersection 108 (130).

### [Remarks]

The present invention is not limited to the embodiment described above, and can be changed freely within the range not departing from the gist of the present invention. Alternatively, the configurations can be combined arbitrarily within the range not contradicting each other technically.

1. A vehicle control device configured to perform travel control of a host vehicle at least partially automatically, comprising:
an intersection recognition unit configured to recognize an intersection that the host vehicle will pass while traveling straight on a travel lane;
an information acquisition unit configured to acquire preceding vehicle information expressing a behavior of a preceding vehicle in a vehicle width direction that precedes the host vehicle and is positioned at the intersection recognized by the intersection recognition unit or a periphery of the intersection; and
a travel control unit configured to perform at least one of lane keeping control for the travel lane and departure prevention control for a lane mark that sections the travel lane, and following control for the preceding vehicle,
wherein the travel control unit is configured to switch and perform the lane keeping control, the departure prevention control, or the following control in accordance with the behavior in the vehicle width direction that is specified from the preceding vehicle information acquired by the information acquisition unit.

2. The vehicle control device according to claim 1, wherein:
the information acquisition unit is configured to acquire a departure distance of the preceding vehicle based on a center line of the travel lane; and
if the departure distance is within a predetermined range whose lower limit value is positive, the travel control unit is configured to perform the following control, and if the departure distance is out of the distance range, the travel control unit is configured to perform the lane keeping control or the departure prevention control.

3. The vehicle control device according to claim 1, wherein:
the information acquisition unit is configured to acquire a departure distance of the preceding vehicle based on the lane mark; and
if the departure distance is less than a predetermined threshold, the travel control unit is configured to perform the following control, and if the departure distance is more than or equal to the threshold, the travel control unit is configured to perform the lane keeping control or the departure prevention control.

4. The vehicle control device according to claim 1, wherein:
the information acquisition unit is configured to acquire lateral speed or lateral acceleration of the preceding vehicle; and
if the preceding vehicle information is less than a predetermined threshold, the travel control unit is configured to perform the following control, and if the preceding vehicle information is more than or equal to the threshold, the travel control unit is configured to perform the lane keeping control or the departure prevention control.

5. The vehicle control device according to claim 1, wherein the information acquisition unit is configured to acquire a statistic value of the preceding vehicle information after the intersection recognition unit has recognized the intersection.

6. The vehicle control device according to claim 1, wherein:
the information acquisition unit is configured to acquire a movement direction of the preceding vehicle; and
if a right/left-turn only lane exists in the movement direction with respect to a position of the preceding vehicle, the travel control unit is configured to perform the lane keeping control or the departure prevention control, and if the right/left-turn only lane does not exist in the movement direction, the travel control unit is configured to perform the following control.

7. The vehicle control device according to claim 1, wherein:
the information acquisition unit is configured to acquire an elapsed time or a travel distance for which the preceding vehicle continuously stays out of the travel lane; and
if the preceding vehicle information is less than a predetermined threshold, the travel control unit is configured to perform the following control, and if the preceding vehicle information is more than or equal to the threshold, the travel control unit is configured to perform the lane keeping control or the departure prevention control.

8. A vehicle control method using a vehicle control device configured to perform travel control of a host vehicle at least partially automatically, comprising:
a recognition step of recognizing an intersection that the host vehicle will pass while traveling straight on a travel lane;
an acquisition step of acquiring preceding vehicle information expressing a behavior of a preceding vehicle in a vehicle width direction that precedes the host vehicle and is positioned at the intersection that is recognized or a periphery of the intersection; and
a control step of performing at least one of lane keeping control for the travel lane and departure prevention control for a lane mark that sections the travel lane, and following control for the preceding vehicle,
wherein in the control step, the lane keeping control, the departure prevention control, or the following control is switched and performed in accordance with the behavior in the vehicle width direction that is specified from the preceding vehicle information that is acquired.
